(19) United States
(12) Patent Application Publication
(10) Pub. No.: US 2006/0198593 A1
(43) Pub. Date: Sep. 7, 2006

(54) Fiber optic cable and optical ground wire coil storage and splice enclosure mounting bracket

(75) Inventor: Niksa Ivancevic, Milwaukee, WI (US)

Correspondence Address: GODFREY & KAHN S.C., 780 NORTH WATER STREET, MILWAUKEE, WI, 53202, US

(73) Assignee: CableCom, LLC

(21) Appl. No.: 11/070,718

(22) Filed: Mar. 2, 2005

(51) Int. Cl. G02B 6/00

(52) U.S. Cl. 385/135

(57) ABSTRACT

A system and method for storing excess fiber optic cable or optical ground wire and for mounting a splice enclosure thereto. The system comprising a bracket having a first member that can be attached to a pole, tower or other support structure. The first member being vertically oriented. The first member having slots or openings extending therethrough for mounting a splice enclosure thereto. The bracket further comprising at least two cross members attached near the ends of the first member. The at least two cross members being horizontally oriented, parallel to each other and perpendicular to the first member. The at least two cross members having at least one coil supporting hook attached to each end of each cross member, wherein each hook is oriented at an angle to avoid damage to the cable.

### BACKGROUND OF THE INVENTION

The present invention relates generally to a system and method for storing fiber optic cable and mounting a splice enclosure, and more particularly to a fiber optic cable and optical ground wire coil storage and splice enclosure mounting bracket.

A significant amount of information is now carried over fiber optic cables. Presently, the majority of telephone and data transmission lines are or are being converted to fiber optics. Fiber optic cables are used extensively in the communications industry due to their large information carrying capacity, their virtual noise-free performance and the long span distances that are achievable before regeneration and/or amplification of the signal is required. Fiber optic cables, however, have their own unique issues which must be addressed. One such issue is the splicing of fiber optic cables. Practical limits on the lengths of fiber optic cables that can be manufactured and installed typically require that many splice and/or drop points be included over the total cable route. Another issue is the storage of the fiber optic cable and optical ground wire.

Fiber optic splices are generally found, among other places, where the lines are brought into a building. When large numbers of splices are required in one place, i.e., at an office building, the splices are typically contained in an enclosure or housing. The splice enclosure is usually cylindrical with an end cap through which the cable enters and exits and a sleeve which covers the structure holding the splices. Typically, these enclosures include a protective housing with one or more splice organizers, or splice trays, on which the individual splices and associated slack are mounted.

One example of a splice enclosure is a Fiber Optic Splice Closure and Metal Closure Organizer (FOSC-MCO) manufactured by Tyco. The FOSC-MCO is a single-ended metal closure specially developed for use on optical grounding wires of overhead electrical network lines. The closure is suitable for use on above ground applications. It can be attached to high voltage towers, poles, walls or other support structures. The purpose of the FOSC-MCO is for terminating and sealing both optical ground wires and conventional fiber optic cables.

Since fiber optic cable cannot be extended and new or repaired splices use up additional cable, it is common to keep an excess amount of cable slack in the enclosure for later splices. There is also a great deal of slack of fiber optic cable and optical ground wire. Storage of excess wire and cable is currently accomplished by merely leaving slack hanging in a sleeve portion or other area of the enclosure. This slack from a large amount of cable which is spliced in an enclosure can quickly become unmanageable.

Additionally, fiber optic cable and optical ground wire has unique physical limitations including a minimum bend radius wherein bending the cable and wire in a radius smaller than the minimum bend radius jeopardizes the integrity of the cable. Therefore, the minimum bend radius must be kept intact. Excess cable and ground wire lengths provided for future additions or changes in splices and/or drop points must be protected against breakage or bending which would affect the transmission properties of the cable.

### SUMMARY OF THE INVENTION

The present invention is directed to a system and method for storing fiber optic cable or optical ground wire and mounting a splice enclosure. The present invention is a system and method for storing excess fiber optic cable or optical ground wire and for mounting a splice enclosure thereto. The system preferably comprises a bracket having a first member that can be attached to a pole, tower or other support structure. The first member is preferably vertically oriented. The first member preferably includes slots or openings extending therethrough for mounting a splice enclosure thereto. The bracket further comprises at least two cross members attached near the ends of the first member. The at least two cross members are preferably horizontally oriented, parallel to each other and perpendicular to the first member. The at least two cross members preferably include at least one coil supporting hook attached to each end of each cross member, wherein each hook is oriented at an angle to avoid damage to the cable.

The first member preferably includes a plurality of slots or openings extending therethrough for attachment of a variety of splice enclosures to the bracket. The mounting member further includes attachment slots or openings extending therethrough for mounting the bracket to a pole, tower or other support structure. The openings preferably include standard spacing for various transmission line or substation support structures.

The at least two cross members are preferably parallel with each other and perpendicular to the first member. The at least two cross members include coil storage hooks attached to each end of each cross member for storing excess fiber optic cable and optical ground wire thereto. Each hook is preferably oriented at an angle. The hooks attached to the cross members provide a diameter not less than the minimum bend radius of the fiber optic cable or optical ground wire to avoid damage to the cable. The distance between the hooks is preferably not less than the bend radius of the fiber optic cable or optical ground wire. Preferably, at least four hooks are used so that the fiber optic cable or optical ground wire can be wound around the bracket in a circular pattern.

In essence the present invention provides a storage structure for storing excess fiber optic cable or optical ground wire thereon and a mounting platform for mounting a splice enclosure thereto.

The present invention also contemplates a method for storing excess fiber optic cable and optical ground wire and for mounting a splice enclosure to a support structure in a communication system. The method comprising the steps of providing a vertically oriented first member that can be attached to a pole, tower or other support structure. The first member preferably having slots or openings extending therethrough for mounting a splice enclosure thereto. The next step includes providing at least two cross members attached near the ends of the first member, the at least two cross members being horizontally oriented, parallel to each other and perpendicular to the first member. And providing coil supporting hooks attached to each end of each cross member for supporting a coil of fiber optic cable or optic ground wire around the splice enclosure.

Various other features, objects and advantages of the invention will be made apparent to those skilled in the art from the accompanying drawings and detailed description thereof.

### BRIEF DESCRIPTION OF THE DRAWINGS

FIG. 1 is a front plan view of a fiber optic cable and optical ground wire coil storage and splice enclosure mounting bracket in accordance with an embodiment of the present invention;

FIG. 2 is a side plan view of the fiber optic cable and optical ground wire coil storage and splice enclosure mounting bracket of FIG. 1;

FIG. 3 is a front plan view of the fiber optic cable and optical ground wire coil storage and splice enclosure mounting bracket of FIG. 1 with fiber optic cable or optical ground wire wound around the bracket and a splice enclosure mounted to the bracket illustrating a main-line splice point; and

FIG. 4 is a front plan view of the fiber optic cable and optical ground wire coil storage and splice enclosure mounting bracket of FIG. 1 with fiber optic cable or optical ground wire wound around the bracket and a splice enclosure mounted to the bracket illustrating a drop splice point.

### DETAILED DESCRIPTION OF THE INVENTION

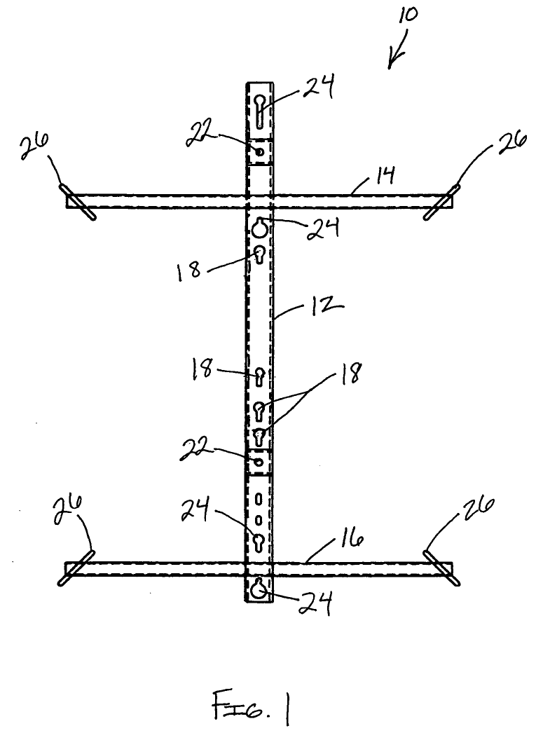

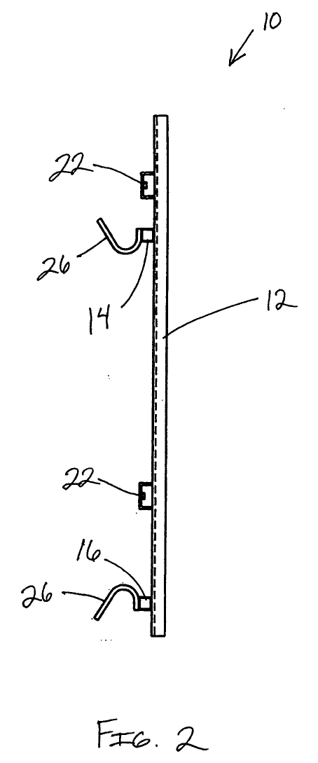

Referring now to the drawings, FIG. 1 is a front plan view of a fiber optic cable and optical ground wire coil storage and splice enclosure mounting bracket 10 in accordance with an embodiment of the present invention. FIG. 2 is a side plan view of the fiber optic cable and optical ground wire coil storage and splice enclosure mounting bracket 10 of FIG. 1. The bracket 10 preferably includes a vertically oriented mounting member 12 that can be attached to a pole, tower or other support structure, and at least two horizontally oriented cross members 14, 16 that are spaced apart from one another and attached to the mounting member 12. The mounting member 12 having two opposed ends, with the at least two cross members 14, 16 attached to the mounting member 12 near the two opposed ends.

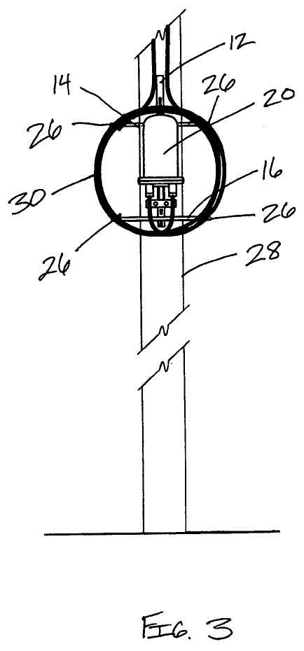

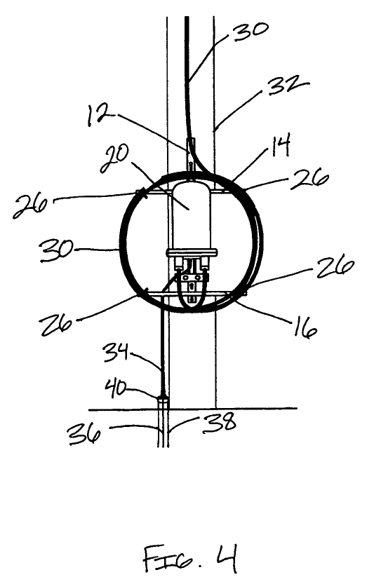

The mounting member 12 preferably includes a plurality of slots or openings 18 extending therethrough for mounting a variety of splice enclosures 20, FIGS. 3 and 4, thereto. The openings 18 are designed for a plurality of different type fastener attachments. The mounting member 12 further includes at least two mounting studs 22 for mounting the housing of a splice enclosure 20 to the mounting member 12. The studs 22 are preferably used to support the housing of a splice enclosure. The mounting member 12 further includes attachment slots or openings 24 extending therethrough for mounting the bracket 10 to a pole, tower or other support structure. The openings 24 preferably include standard spacing for various transmission line or substation support structures.

The at least two cross members 14, 16 are preferably parallel with each other and perpendicular to the mounting member 12. Each cross member 14, 16 has two opposed ends. The at least two cross members 14, 16 include coil storage hooks 26 attached to each end of each cross member 14, 16 for storing excess fiber optic cable or optical ground wire thereto. Each hook 26 is oriented at an angle, the angles of the two hooks 26 at each end of each cross member 14, 16 being supplementary angles that add up to 180 degrees. The hooks 26 attached to the cross members 14, 16 provide a diameter not less than the minimum bend radius of the fiber optic cable or optical ground wire to avoid damage to the cable. The vertical distance between the cross members 14, 16 and the horizontal distance between the hooks 26 depends on the amount of cable intended to be held and the bend radius of the cable.

Examples of splice enclosures that may be mounted to the bracket 10 include, but are not limited to a Tyco FOSC-MCO splice enclosure, a Tyco Gel type splice enclosure, an Alcoa SB-1 splice enclosure, an Alcoa Opti-Gard splice enclosure, etc.

FIG. 3 is a front plan view of the fiber optic cable and optical ground wire coil storage and splice enclosure mounting bracket 10 of FIG. 1 with fiber optic cable or optical ground wire wound around the bracket 10 and a splice enclosure 20 mounted to the bracket 10 illustrating a main-line splice point. The bracket 10 is shown mounted to a transmission line structure 28 with fasteners. The radius of the hooks 26 is preferably not less than the minimum bend radius of the fiber optic cable or optical ground wire.

The splice enclosure 20 generally includes a housing having a closed end and an open end covered by an end cap. The end cap has openings through which fiber optic cable or optical ground wire enters and exits the enclosure. A splice tray attachment in the enclosure is preferably attached to the end cap and includes mounting clips for mounting the splice trays thereto. Each of the splice trays preferably includes a plurality of cable splice holders for holding the individual splices.

FIG. 4 is a front plan view of the fiber optic cable and optical ground wire coil storage and splice enclosure mounting bracket 10 of FIG. 1 with fiber optic cable or optical ground wire wound around the bracket 10 and a splice enclosure 20 mounted to the bracket illustrating a drop splice point. The bracket 10 is shown mounted to a substation structure 32 with fasteners. The drop splice includes a conduit 34 extending from the end cap of the splice enclosure. The conduit 34 having a fiber optic cable or optical ground wire 36 therein that extends through an end cap 40 and a duct 38. The radius of the hooks 26 is preferably not less than the minimum bend radius of the fiber optic cable or optical ground wire.

In a preferred embodiment, the bracket of the present invention is preferably made of a galvanized steel construction. Alternatively, the bracket may be made of a high density injected molded plastic. However, any of a number of materials known to those in the art can be used.

While the invention has been described with reference to preferred embodiments, those skilled in the art will appreciate that certain variations, alterations, modifications, substitutions and omissions may be made to the embodiments without departing from the spirit of the invention. Accordingly, the foregoing description is meant to be exemplary only, and should not limit the scope of the invention as set forth in the following claims.

1. A system for storing fiber optic cable and mounting a splice enclosure comprising:
a first member that can be attached to a pole or other support structure;
at least two cross members attached near the ends of the first member; and
at least two coil supporting hooks, each rigidly attached to a respective opposite end of one of the cross members, each hook extending away from the hook at the opposite end of the cross member.

2. The system of claim 1, wherein the first member is vertically oriented.

3. The system of claim 1, wherein the first member includes slots or openings extending therethrough.

4. The system of claim 1, wherein the at least two cross members are horizontally oriented, parallel to each other and perpendicular to the first member.

5. The system of claim 1, wherein each coil supporting hook is oriented at an angle neither parallel nor perpendicular to the cross member to which the respective coil supporting hook is attached.

6. A fiber optic cable and optical ground wire coil storage and splice enclosure mounting bracket comprising:
a first member that can be attached to a pole, tower or other support structure, the first member being vertically oriented;
at least two cross members attached near the ends of the first member, the at least two cross members being horizontally oriented, parallel to each other and perpendicular to the first member; and
at least two coil supporting hooks, each rigidly attached to a respective opposite end of one of the cross members, each hook extending away from the hook at the opposite end of the cross member.

7. The bracket of claim 6, wherein the first member includes slots or openings extending therethrough.

8. The system of claim 6, wherein each coil supporting hook is oriented at an angle neither parallel nor perpendicular to the cross member to which the respective coil supporting hook is attached.

9. A method for storing fiber optic cable and mounting a splice enclosure, the method comprising the steps of:
attaching a first member to a pole, tower or other support structure;
attaching at least two cross members near the ends of the first member, the at least two cross members being substantially parallel to each other and perpendicular to the first member;
attaching a coil supporting hook rigidly to each end of each cross member, and orienting the hook so as to extend away from the hook at the opposite end of the cross member, for supporting a coil of fiber optic cable or optic ground wire around the splice enclosure.

10. The method of claim 9, wherein the first member includes slots or openings extending therethrough for mounting a splice enclosure thereto.

11. The system of claim 1 wherein the distance from the center of the cross member to each hook is at least as large as the larger of the minimum bend radius of the fiber optic cable.

12. The system of claim 6 wherein the distance from the center of the cross member to each hook is at least as large as the greater of the minimum bend radius of the fiber optic cable and the minimum bend radius of the optic ground cable.

13. The system of claim 9 wherein the distance from the center of the cross member to each hook is at least as large as the larger of the minimum bend radius of the fiber optic cable and the optic ground wire.
